(19) United States
(12) Patent Application Publication
(10) Pub. No.: US 2016/0103527 A1
(43) Pub. Date: Apr. 14, 2016

(54) IDENTIFICATION AND DATA INTERCHANGE SYSTEM HAVING A PORTABLE CAPACITIVE DEVICE AND A CAPACITIVE TOUCH SCREEN

(71) Applicant: THALES, Courbevoie (FR)

(72) Inventors: Philippe CONI, Saint Jean d'lllac (FR); Johanna DOMINICI, Le Haillan (FR); Jean-Christophe ABADIE, Biganos (FR)

(21) Appl. No.: 14/879,068

(22) Filed: Oct. 8, 2015

(30) Foreign Application Priority Data
Oct. 10, 2014 (FR) 1402279

(51) Int. Cl. G06F 3/044; G06K 9/00; G06F 1/16; G06F 3/01; G06F 3/041; G06F 3/0354

(52) U.S. Cl. CPC G06F 3/044; G06F 3/0412; G06F 3/03545; G06F 1/163; G06F 1/1635; G06F 3/016; G06K 9/00087; G06F 2203/04104; G06F 2203/04102

(57) ABSTRACT

The general field of the invention is that of systems having a capacitive touch screen. The system according to the invention has a portable capacitive device that is intended, in operational mode, to be carried by a user. The touch screen operates at at least one first frequency. The system operates according to at least one first identification mode in which the portable device has transmission means for transmitting a first periodic analogue signal that is transmitted at a second frequency, referred to as “identification” frequency, that is different from the first frequency, said frequency being in a range of frequencies that are transmitted by the human body, said first signal being unique and associated with the user. The portable touch screen has first means for detecting and identifying said first signal and second means for authorizing or denying access to predetermined applications of the touch screen, which are dependent on the identification of the user. Other modes of operation of the system are possible.

The field of the invention is that of visual display devices having a capacitive touch screen. The more particular field of the invention is that of interchanges of information with the touch screen, allowing secure recognition of the user, inter alia. All fields of application requiring this type of interchange are affected. The consumer field will be cited but also the field of transport of any nature, automotive, aeronautical, rail or maritime.

Current touch systems do not allow direct identification of the persons performing interactions. Thus, on a shared screen, it is not possible to distinguish the touch of a first person from the touch of a second person, just as it is not possible to reject the touch of a third person who is not authorized to use the system. In the same way, the involuntary presence of a conductive object on a capacitive panel can give rise to an untimely touch.

This problem of identifying the user can be handled indirectly by means of a finger print reader, as can be found on mobile phones from the “IPhone 5” brand that are marketed by the “Apple” company, but nothing prevents a third party from using the screen once it has been unlocked. In fact, the system recognizes the operator only once, namely at the moment of unlocking.

In order to achieve total security, it is necessary to be able to detect and recognize the operator when he interacts with the touch screen using one or more fingers, and it is likewise necessary to detect and recognize other operators who perform operations simultaneously or separately, using one or more fingers, on the same screen. The identification and data interchange system according to the invention provides this function. More precisely, the subject of the invention is an identification and data interchange system having a portable capacitive device and a capacitive touch screen, said portable capacitive device being intended, in operational mode, to be carried by a user, the touch screen operating at least one first frequency,

characterized in that said system operates according to at least one first identification mode,

the portable device having at least transmission means for transmitting a first periodic analogue signal, said first signal being transmitted at at least one second frequency, referred to as “identification” frequency, said second frequency being different from the first frequency, said frequency being in a range of frequencies that are transmitted by the human body, said first signal being unique and associated with the user;

the portable touch screen having first means for detecting and identifying said first signal and second means for authorizing or denying access to predetermined applications of the touch screen, which are dependent on the identification of the user.

Advantageously, the system operates according to at least one second digital data interchange mode,

the portable device having means for transmitting a second periodic analogue signal that is representative of first digital data, said second signal being transmitted at least one frequency that is different from the first frequency, and means for receiving and analysing a third received signal from the touch screen that is representative of second digital data, said third signal being transmitted at least one frequency that is different from the first frequency;

the capacitive touch screen having means for receiving and analysing the second signal and means for transmitting the third signal.

Advantageously, the portable capacitive device has its own earthing means.

Advantageously, the various frequencies transmitted by the portable capacitive device and/or the capacitive touch screen are orthogonal.

Advantageously, the portable capacitive device has at least one sensor for analysing at least one vital parameter of the user and the capacitive touch screen has at least one specific application, which is dependent on said vital parameter.

Advantageously, the portable capacitive device has haptic or visual means for interaction with the user.

Advantageously, the portable capacitive device has means for interacting with a position or orientation detection system, which are designed to detect its position in relation to a known reference frame.

Advantageously, the portable capacitive device has means for interacting with an oculometer, which are designed to detect the direction in which the user is looking.

Advantageously, the portable capacitive device has means for interchanging data with at least one second capacitive touch screen.

Advantageously, the portable capacitive device has a rechargeable battery.

Advantageously, the portable capacitive device is in the form of a ring that is intended to be worn on the wrist or on the finger of the user. It may likewise be in the form of a stylus or pen.

The invention will be better understood and other advantages will emerge upon reading the description that follows and that is provided without implying limitation and by means of the appended figures, among which:

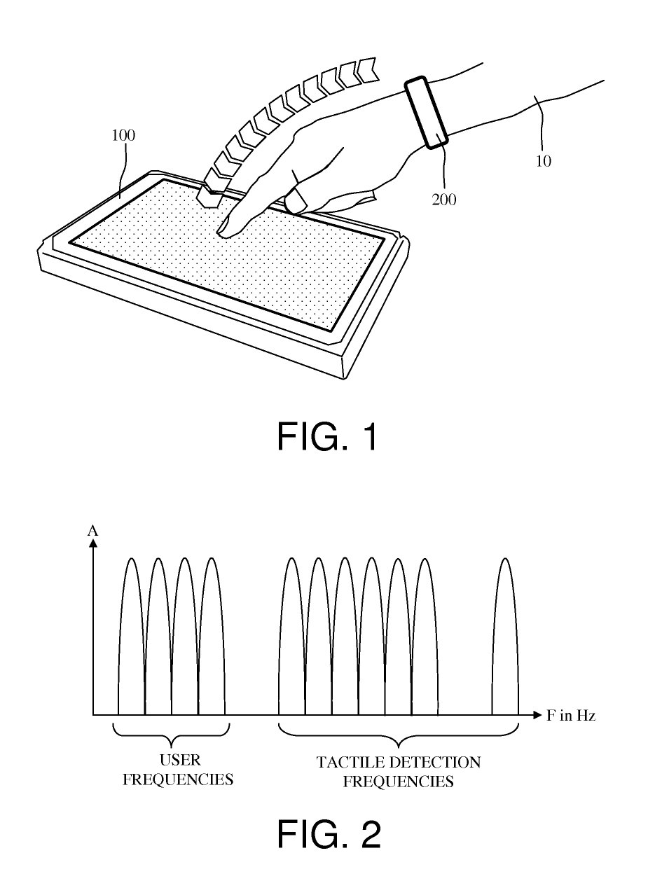

FIG. 1 shows the mode of operation of an identification and data interchange system according to the invention;

FIG. 2 shows the various frequencies used in an identification and data interchange system according to the invention;

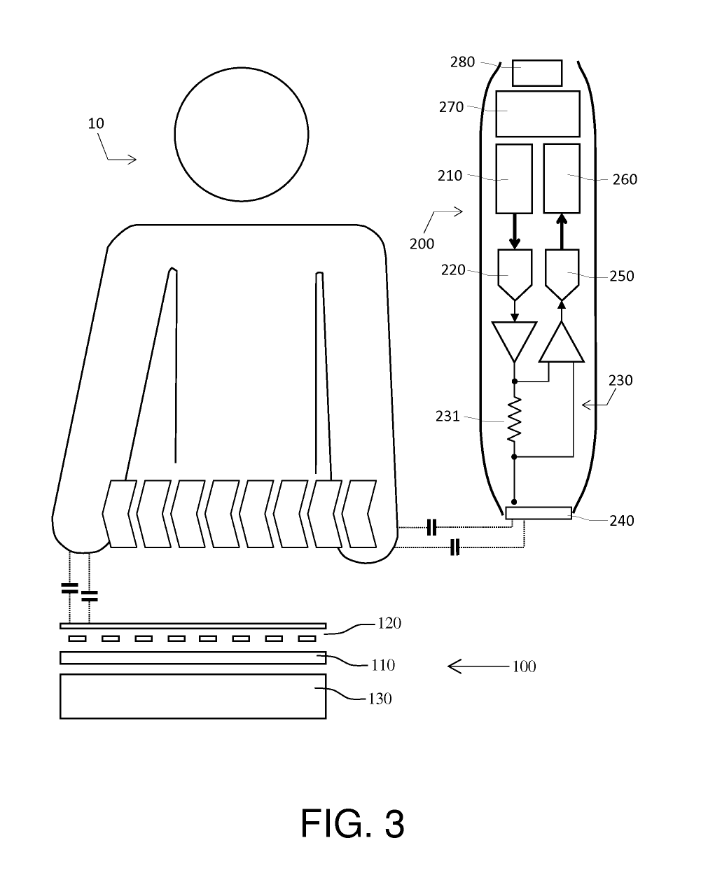

FIG. 3 shows an electronic diagram of an identification and data interchange system according to the invention.

By way of non-limiting example, FIG. 1 shows a view of a system according to the invention. An identification and data interchange system according to the invention essentially has a capacitive touch screen 100 and a portable capacitive device 200 that is carried by a user 10.

As can be seen in FIG. 3, the capacitive touch screen 100 comprises a visual display screen 110, a matrix touch panel 120 and its dedicated electronics 130. The matrix 120 is made up of conductive rows and columns that are usually made of “ITO”, the acronym for “Indium Tin Oxide”. Typically, such a touch-sensitive surface can have around fifty columns and around thirty rows for an avionics instrument panel screen. The dedicated electronic part 130 essentially has:
means for transmitting first periodic signals intended to supply power to the rows and columns;
means for receiving second periodic signals from the rows and columns;
means for digitally processing the received signals allowing determination of the capacitance variations induced in the rows and columns of the matrix, thus allowing contacts by the user using the touch panel to be located;
an input/output interface with the visual display screen 110 allowing the applications to be managed according to the detected contacts.

Touch detection can be effected in what is known as “self-capacitance” mode and/or in “mutual capacitance” mode. The first mode consists in reading the rows and columns of the network of keys in the matrix. The second mode consists in reading each intersection of the network of rows and columns in the matrix. The first mode allows rapid examination of the touch-sensitive surface and location of the possible coordinates of the touches. The second mode allows real touches to be separated from “phantom” touches.

The touch-sensitive surface according to the invention moreover has specific means. These are:
first means for detecting and identifying a first external signal that is representative of a user;
second means for authorizing or denying access to predetermined applications of the touch screen, which are dependent on the identification of said first signal.

The portable capacitive device according to the invention is carried by a user 10. It has several functions. All these functions are based on the ability of the portable capacitive device to transmit and receive digital data by using the signal transmission and reception properties of the touch panel, and on the properties of frequency transmission by the body of the user. In FIGS. 1 and 3, the transmission by the human body is symbolized by a succession of chevrons. In FIG. 2, the electrical links between the user 10 and firstly the portable capacitive device and secondly the touch panel 100 are represented by electrical capacitances.

The portable capacitive device is in the form of a ring or a band or a bracelet or a glove in electrical contact with the user. It can likewise be presented in the form of a stylus or pen. In FIG. 1, the device 200 is a ring arranged around the wrist of the user 10. It can have various interfaces with the user, such as start buttons, indicator lights, a display screen, state sensors or else haptic feedback means.

Its first function is a function for identifying the user. Its second function is a function for interchanging data with the touch panel. Its third function is a function for interacting with the user.

Its first function is to allow the user to be identified when he touches the capacitive touch screen. This identification is performed by means of a signal that is sent by the portable object to the capacitive touch panel, this signal being specific to each user. The identification signal is transmitted by the body of the user to beneath the tip of his fingers. Once the user has been identified, the system allocates associated privileges to the user. By way of example, it authorizes him to interact on a specific area of the screen, or conversely prohibits him from accessing an area, or even all of the screen. Thus, the critical areas or interactors are available only to users having the authorized identification signal.

The frequency and the waveform of the transmitted frequency signal are adapted to transmission through the human body. This signal is demodulated by the touch controller of the touch-sensitive surface at the same time as the capacitive measurement signals. The frequencies are in a range of frequencies below 1 MHz.

The portable capacitive device has electronics allowing the generation of a signal with a frequency of its own, onto which a serial signal is modulated. This signal can be repetitive and contain an identifier, possibly followed by a container containing a set of digital data.

Each portable capacitive device transmits on a particular frequency, in a finite frequency domain, that is continuously examined by the touch controller of the touch panel.

The touch controller has the ability to perform amplitude demodulation on frequency signals allowing the rows and columns of the touch screen to be read and likewise has the ability to demodulate the signals from the portable capacitive device.

As can be seen in FIG. 2, which shows the amplitude A of the signals as a function of their transmission frequencies F, one frequency space intended for the portable capacitive devices and a second frequency space intended for the capacitive measurement of the touch panel are thus defined. As for ADSL transmission, ADSL meaning “asymmetric digital subscriber line”, the frequencies are advantageously “orthogonal” and can thus be demodulated independently of one another. Two signals are said to have orthogonal frequencies if their integration time is identical for the various demodulation means of the processing electronics, this integration time being an exact multiple of each of the periods.

The portable capacitive device is not limited to simple transmission of an identification code. Its second function is to interchange information with the touch screen.

The portable device then has means for transmitting a periodic analogue signal that is representative of digital data, said signal being transmitted at a frequency that is different from the measurement frequency of the touch panel. The portable device likewise has means for receiving and analysing a received signal from the touch screen that is likewise representative of digital data.

The capacitive touch screen has means for receiving and analysing the signal from the portable device and means for transmitting its own data signal.

As an example of application, the portable capacitive device can be connected to an external memory, a portable telephone or “smart phone” or to any other digital information source and can thus allow this content to be transferred to the touch screen.

In the same way, by means of a dedicated application on a smart phone or an equivalent digital device, the user can denote a digital content with his finger in order to perform the computer function “copy”, and can then place his finger on the touch screen in order to “paste” said content.

The portable device may also have other applications. Thus, the portable capacitive device may have one or more sensors for analysing vital parameters or the emotional state of the user. The capacitive touch screen can have one or more specific applications, depending on these vital parameters or on the emotional state. Thus, the portable device can be used as a means for monitoring the state of health and/or attentiveness of the user and can allow the touch screen to be adapted to this state. As an example of adaptations of the touch screen, the generation of vibrations, the modification of the displayed symbology or the generation of specific warning messages will be cited.

Conversely, the touch screen can transmit messages either of haptic type, causing the portable device to vibrate, or of visual type, causing lights or visual display screens incorporated in the portable device to turn on, thus alerting the user.

The portable device can be used as a means of validation coupled to a device for detecting the eye or the direction of view or oculometer, also known by the term “eye tracker”, the latter allowing simple and rapid denotation of the objects to be selected. This method of denotation is quite particularly adapted to the various visual display screens. The portable capacitive device can likewise have means for interacting with a position and/or orientation detection system, which are designed to detect its position in relation to a known reference frame.

FIG. 3 shows the essential subsystems of the electronic part of a portable device according to the invention. It has the following various electronic means:
a voltage generator 210;
a DAC converter 220;
an analogue transmission/reception subsystem 230 that is capable of generating and receiving sinusoidal voltages on a conductive part 240. In the diagram in FIG. 3, in reception mode, the capacitive current from the generator of the touch-sensitive surface is measured by a resistor 231 whose order of magnitude is typically 1 KO;
an ADC converter 250;
synchronous demodulation circuits 260;
digital processing means 270 for processing the signals from the synchronous demodulations allowing determination of the capacitance variations induced in the rows and columns of the matrix. Each demodulator allows the amplitude and the phase of the processed signal to be delivered;
storage means 280 for storing the various data required for the portable device to operate and, in particular, the identification code specific to the user.

The electrical reference potential of the analogue circuits 230 or “earth” is connected to an outer conductive part in contact with the hand of the operator in order to obtain the essential common-mode feedback through the “earth”. This function can naturally be provided by means of simple contact between the device and the user through his clothes, his headset, his shoes or by means of his seat if he is sitting down.

The portable capacitive device can likewise have integrated means of its own allowing this function to be performed. A simple electrical cable of appropriate length is enough to provide the earth return. This length does not exceed a few centimetres.

The power supply to the portable device can be provided by a battery or a storage battery. In the latter case, the portable device can be recharged by means of induction or by any other wireless or contactless recharging means. This supply is not shown in FIG. 3.

1. An identification and data interchange system having a portable capacitive device and a capacitive touch screen, said portable capacitive device being intended, in operational mode, to be carried by a user, the touch screen operating at least one first frequency,
wherein said system operates according to at least one first identification mode,
the portable device having at least transmission means for transmitting a first periodic analogue signal, said first signal being transmitted at least one second frequency, referred to as “identification” frequency, said second frequency being different from the first frequency, said frequency being in a range of frequencies that are transmitted by the human body, said first signal being unique and associated with the user;
the portable touch screen having first means for detecting and identifying said first signal and second means for authorizing or denying access to predetermined applications of the touch screen, which are dependent on the identification of the user;
the various frequencies transmitted by the portable capacitive device and/or the capacitive touch screen being orthogonal.

2. The identification and data interchange system according to claim 1, wherein the system operates according to at least one second digital data interchange mode,
the portable device having means for transmitting a second periodic analogue signal that is representative of first digital data, said second signal being transmitted at least one frequency that is different from the first frequency, and means for receiving and analysing a third received signal from the touch screen that is representative of second digital data, said third signal being transmitted at least one frequency that is different from the first frequency;
the capacitive touch screen having means for receiving and analysing the second signal and means for transmitting the third signal.

3. The identification and data interchange system according to claim 1, wherein the portable capacitive device has its own earthing means.

4. The identification and data interchange system according to claim 1, wherein the portable capacitive device has at least one sensor for analysing at least one vital parameter of the user and in that the capacitive touch screen has at least one specific application, which is dependent on said vital parameter.

5. The identification and data interchange system according to claim 1, wherein the portable capacitive device has haptic or visual means for interaction with the user.

6. The identification and data interchange system according to claim 1, wherein the portable capacitive device has means for interacting with a position and/or orientation detection system, which are designed to detect its position in relation to a known reference frame.

7. The identification and data interchange system according to claim 1, wherein the portable capacitive device has means for interacting with an oculometer, which are designed to detect the direction in which the user is looking.

8. The identification and data interchange system according to claim 1, wherein the portable capacitive device has means for interchanging data with at least one second capacitive touch screen.

9. The identification and data interchange system according to claim 1, wherein the portable capacitive device has a rechargeable battery.

10. The identification and data interchange system according to claim 1, wherein the portable capacitive device is in the form of a ring that is intended to be worn on the wrist or on the finger of the user.

11. The identification and data interchange system according to claim 1, wherein the portable capacitive device is in the form of a stylus or pen.
